(19) United States
(12) Patent Application Publication
(10) Pub. No.: US 2017/0059529 A1
(43) Pub. Date: Mar. 2, 2017

(54) ADAPTIVE ADDITIVE MANUFACTURING PROCESS USING IN-SITU LASER ULTRASONIC TESTING

(71) Applicant: Siemens Energy, Inc., Orlando, FL (US)

(72) Inventors: Ahmed Kamel, Orlando, FL (US); Anand A. Kulkarni, Charlotte, NC (US)

(21) Appl. No.: 14/833,365

(22) Filed: Aug. 24, 2015

(51) Int. Cl. G01N 29/07; B22F 3/24; B23K 26/342; G01L 1/25; C21D 1/42; C21D 1/34; C21D 10/00; B22F 3/105; C21D 1/30

(52) U.S. Cl. CPC G01N 29/07; B22F 3/1055; B22F 3/24; B23K 26/342; C21D 1/30; C21D 1/42; C21D 1/34; C21D 10/005; G01L 1/255; B33Y 10/00

(57) ABSTRACT

An additive manufacturing process, including: selectively-heating a layer of powder (18) to form a solid deposit layer (10) having a solid deposit (28), where the solid deposit layer constitutes part (24) of a component, via a selective laser heating process; propagating ultrasonic energy waves (50, 60) through the solid deposit prior to completion of the component by using a wave generating laser (40) set apart from a surface (44) of the solid deposit to direct a wave-generating laser beam (42) at the surface; detecting propagated ultrasonic energy waves (62); assessing the propagated ultrasonic waves for information about a physical characteristic of the solid deposit; and forming another solid deposit layer (80) in response to the information obtained about the solid deposit.

### FIELD OF THE INVENTION

The present invention is related to in-situ, laser ultrasonic testing of a component that occurs between formation of layers in an additive manufacturing process.

### BACKGROUND OF THE INVENTION

Additive manufacturing often starts by slicing a three dimensional representation of an object to be manufactured into very thin layers, thereby creating a two dimensional image of each layer. To form each layer, popular laser additive manufacturing techniques such as selective laser melting (SLM) and selective laser sintering (SLS) involve mechanical pre-placement of a thin layer of metal powder of precise thickness on a horizontal plane. Such pre-placement is achieved by using a mechanical wiper to sweep a uniform layer of the powder or to screed the layer, after which an energy beam, such as a laser, is indexed across the powder layer according to the two dimensional pattern of solid material for the respective layer. After the indexing operation is complete for the respective layer, the horizontal plane of deposited material is lowered and the process is repeated until the three dimensional part is completed.

Physical characteristic of a completed part of concern include defects (voids, cracks etc.) as well as an amount of residual stress, in part because residual stress can cause warping and premature cracking. Knowledge of the amount of residual stress in the solid part of the component can be determined using known techniques such as center-hole drilling. However, this requires material removal and is therefore at least semi-destructive. X-ray and neutron diffraction techniques are non-destructive, but they are expensive and cannot be carried out in-situ. In addition, these techniques require the removal of the component for the evaluation to be performed. Magnetic testing is also non-destructive, but it relies on an interaction between magnetization and elastic strain in ferromagnetic material. Consequently, magnetic testing is necessarily limited to ferromagnetic materials. Laser ultrasonic detection of physical characteristics is known in the welding and joining field, but little is known in the additive manufacturing field, and these are not performed concurrent with formation of the component and/or directly on the component being formed. Accordingly, there remains room in the art for an improved, non-destructive process for detection of a physical characteristic such as residual stress or defects.

### BRIEF DESCRIPTION OF THE DRAWINGS

The invention is explained in the following description in view of the drawings that show:

FIG. 1 depicts a laser additive manufacturing process.

FIG. 2 depicts a laser ultrasonic physical characteristic detection process.

FIG. 3 depicts an option of forming a solid deposit layer after the laser ultrasonic physical characteristic detection process by differing the parameters used during the additive manufacturing process.

FIG. 4 depicts an option of performing a residual stress-relieving process after the laser ultrasonic physical characteristic detection process.

FIG. 5 depicts the laser additive manufacturing process and the laser ultrasonic physical characteristic detection process being performed on a solid deposit.

FIG. 6 is a flow chart depicting an exemplary embodiment of an additive manufacturing process employing a laser ultrasonic physical characteristic detection process.

### DETAILED DESCRIPTION OF THE INVENTION

As with many manufacturing process, selective laser heating processes (e.g. SLM, SLS) result in physical characteristics, such as a defect and/or a buildup of residual stress. The level of residual stress can be high and can affect the structural integrity of the component. Consequently, it is beneficial to know the amount of residual stress present as well as any other defects. The inventors have recognized that residual stress may occur within each layer and may build up with the formation of additional layers, and that it will be beneficial to identify physical characteristics during the additive manufacturing process.

Prior techniques associated with residual stress control in, for example, building up of a blade tip, include alternating the application of the laser beam from side to side to even-out the residual stresses. These parts can then be heat treated to further alleviate the residual stresses. However, these processes do not necessarily measure the residual stress during formation of the component, but instead predict its presence as a predetermined quantity and then accommodate/alleviate the assumed residual stress. It is known that characteristics of a melt pool used to form a layer in an additive manufacturing process may be evaluated by using a camera to capture an image of the melt pool. However, while this technique provides information about the melt pool, it does not provide information about physical characteristics that may be present after the melt pool solidifies, nor of the layers under the melt pool.

The present inventors have developed an additive manufacturing process that monitors physical characteristics within a component as the component is being formed and adapts the additive manufacturing process in response to what is learned about the physical characteristics. The physical characteristic (e.g. residual stress) is monitored using a laser ultrasonic physical characteristic detection process that uses a laser disposed apart from the component to direct a wave-generating laser beam onto a surface of a most-recently formed solid deposit layer. Non-contact, laser ultrasonic physical characteristic detection processes are known in the art as described by, for example, Daniel Levesque et al., Defect Detection and Residual Stress Measurement in Friction Stir Welds using Laser Ultrasonics, 1st International Symposium on Laser Ultrasonics: Science, Technology and Applications. Jul. 16-18 2008, Montreal, Canada. Laser ultrasonic detection of residual stress is described by, for example, Karabutov, Alexander et al., Laser Ultrasonic Diagnostics of Residual Stress, Ultrasonics, 48, 631-635 (2008).

In such a process the wave-generating laser beam causes sounds waves to propagate through the most-recently formed solid deposit layer as well as through any underlying solid deposit layers. The ultrasonic energy waves are reflected within the component and the reflected ultrasonic energy waves may be detected by a wave-detecting laser beam using known techniques. The ultrasonic energy waves are analyzed and residual stress and/or defects in the most-recently formed solid deposit layer and/or any underlying solid deposit layers can be determined. If desired, the additive manufacturing process may be adjusted as necessary to accommodate and/or mitigate the residual stress. Adjustments include changing the way a subsequently formed solid deposit layer is formed and/or performing a residual stress-relieving process on the component before forming another solid deposit layer.

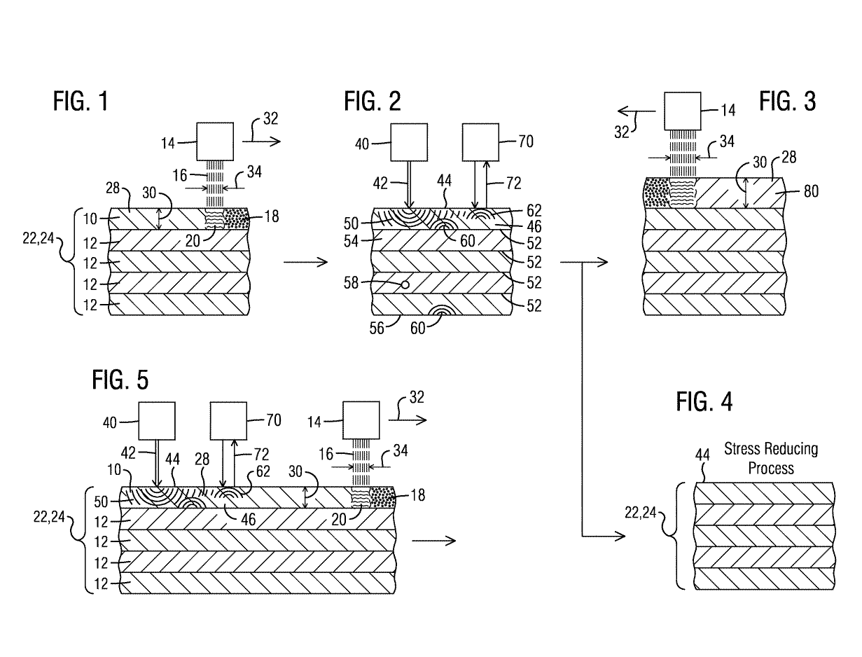

FIG. 1 depicts an exemplary embodiment of a laser additive manufacturing process where a solid deposit layer 10 is being formed on previously formed solid deposit layers 12. During the additive manufacturing process a heating laser 14 selectively directs a laser beam 16 toward powder 18 to heat the powder 18 to form the solid deposit layer 10. The laser beam 16 may sinter the powder particles together as part of a selective laser sintering process. Alternately, the laser beam 16 may melt the powder particles together into a melt pool 20 which then solidifies to form the solid deposit layer 10. The solid deposit layer 10 and the previously formed solid deposit layers 12 constitute a stack 22 that is part 24 of a component (not shown) being formed. During formation of the solid deposit layer 10 one or more solid deposits 28 are formed that, when the layer is complete, form the solid deposit layer 10. One solid deposit 28 may be formed and grow continuously until the solid deposit layer 10 is formed. Alternately, plural, discrete solid deposits 28 may be formed in any pattern until they unite to form the solid deposit layer 10.

The selective laser heating process may be performed using a set of parameters. The process parameters include powder-related parameters, such as a particle size, and a layer thickness 30 etc. The size of the powder particles may be varied for an entire layer or it may be varied locally within a layer. For example, finer powder particles require less energy to heat, while larger particle size requires more heat. Particle size may then be varied to match local heating requirements needed to relieve local residual stress.

These process parameters may also include laser-related parameters such as a direction 32 of laser beam traversal, laser beam energy, laser beam diameter 34, laser beam traversal rate (across the powder). In the case of a pulse-laser, the laser characteristics may include pulse characteristics such as frequency and duration etc. In addition, the laser path taken when forming the solid deposit layer 10 may vary. For example, instead of following a path from one end to another end of the deposited powder 18 to form the solid deposit layer 10, the laser beam 16 may jump around from one location to another remote location in the deposited powder 18. In such an instance the laser beam 16 may first process a location or locations in the powder 18 in a manner effective to relieve residual stress that has been detected, and then process a remainder of the powder 18 to complete the solid deposit layer 10.

FIG. 2 depicts a laser ultrasonic physical characteristic detection process. The process may be implemented after completion of a solid deposit layer 10, in which case a wave generating laser 40 emits a wave generating laser beam 42 that is directed toward a surface 44 of a most recently formed solid deposit layer 46. Alternately, or in addition, the process may be implemented during formation of the solid deposit layer 10. In this exemplary embodiment the wave-generating laser 40 emits the wave-generating laser beam 42 toward the surface 44 of the solid deposit, which is the solid portion of the partially formed solid deposit layer 10. The process is generally described herein with respect to a solid deposit layer 10, but the principles are understood as being applicable to the solidified portion (e.g. the solid deposit) of a forming solid deposit layer 10.

The wave-generating laser 40 may be located remote from the surface (i.e. not in contact with the surface 44) during this process. When the wave-generating laser beam 42 contacts the surface 44 ultrasonic energy waves 48 are generated. These ultrasonic energy waves 50 propagate through the most recently formed solid deposit layer 46 and may reflect of any number of features. These features include an interface 52 such as the interface 52 between the most recently formed solid deposit layer 46 and an adjacent underlying deposit layer 54, a bottom surface 56 of the stack 22, or a defect 58 such as a void or a crack. Upon encountering these features the ultrasonic energy waves 48 may be reflected, thereby creating reflected ultrasonic energy waves 60. The reflected ultrasonic energy waves 60 propagate through the stack 22 until eventually reaching the surface 44. A wave-detecting laser 70 generates a wave-detecting laser beam 72 that is directed toward the surface 44 and reflected back toward the wave-detecting laser 70, carrying with it information about the reflected ultrasonic energy waves 60. Alternately, some of the ultrasonic energy waves 50 may travel unobstructed through the most recently formed solid deposit layer 46 until being detected by the wave-detecting laser 70. Consequently, propagated energy waves 62 detected by the wave-detecting laser 70 may include unobstructed ultrasonic energy waves 50 and/or reflected ultrasonic energy waves 60.

In an exemplary embodiment the heating laser 14, the wave-generating laser 40, and the wave-detecting laser 70 may be separate lasers. Alternately, a single laser may be any two or all three of the lasers 14, 40, 70. For example, a single laser may be used to process the powder 18 and then to ping the surface 44 to generate the ultrasonic energy waves 50. That same single laser may also be used to detect the propagated energy waves 62, or a separate laser may be used to detect the propagated energy waves 62. When detecting the propagated waves the wave-detecting laser 70 may be used in conjunction with, for example, an interferometer, as is known in the art.

Physical characteristics of a material through which energy waves pass can change characteristics of the energy wave. Consequently, the propagated energy waves 62 carry information about physical characteristics of the most recently formed solid deposit layer 46 and/or the previously formed solid deposit layers 12. Analysis of the characteristics of the propagated energy waves 62 enables a determination to be made about the physical characteristics, including whether certain features are present (e.g. voids and/or cracks) as well as an amount of residual stress that is present.

Information may be gleaned directly from the characteristics of the propagated energy waves 62. For example, if a characteristic (e.g. amplitude etc.) of the propagated energy wave falls to one side or another of a threshold a predetermined action may be taken, such as a change in the additive manufacturing process to alleviate or compensate for residual stress. Alternately, or in addition, the characteristics of the propagated energy waves 62 may be evaluated and physical characteristics inferred from the evaluation. These physical characteristics may then be assessed for acceptability and if unacceptable, action may be taken, such as a change in the additive manufacturing process to alleviate or compensate for residual stress. In the instance of a found defect, the additive manufacturing process may be halted to reword and then finish the part, or to scrap the part.

The laser ultrasonic physical characteristic detection process is performed on the most recently formed solid deposit layer 46 where it is in a solid state. For example, the laser ultrasonic detection process may be performed after the entire most recently formed solid deposit layer 46 has been formed and cooled to ambient temperature. The laser ultrasonic detection process may be performed immediately after the powder 18 has been treated with the laser, in which case the material being processed will be relatively warm. In the case of selective laser melting, the material may be near its melting temperature. Since characteristics and an amount of residual stress changes as a material cools, the residual stress detected in the latter instance is not the same as it will be once the component is complete and at ambient temperature.

Parametric data may be used to draw an association between the detected residual stress at a relatively warm temperature and what the residual stress will be after further cooling. Performing the laser ultrasonic detection process soon after the laser treatment is complete may save a substantial amount of time when compared to the time taken to wait for the part to cool and then perform the laser ultrasonic detection process. This may also allow for less drastic corrective action that may pre-empt the formation of the residual stress predicted to form during the cooling subsequent to the laser ultrasonic detection process. The parametric data may be developed by actually measuring residual stress in components at varying temperatures and states of completion etc. and applying that data to measured data. Alternately, or in addition, the residual stress when cool may be predicted through various modeling algorithms and the like.

In an exemplary embodiment, the laser ultrasonic detection process may occur as often as every time a solid deposit layer 10 is formed. Alternately, the laser ultrasonic detection process may occur at predetermined intervals, such as every other solid deposit layer 10, or every third etc. Other factors may be included in the process used to determine when the laser ultrasonic detection process should occur, including a geometry of the component and/or the solid deposit layer 10. For example, where a stress riser such as a fillet is being formed, or any geometry subject to high residual stress upon cooling is being formed, the laser ultrasonic detection process may occur more frequently during component formation. Conversely, when the geometry is less prone to residual stress, the laser ultrasonic detection process may occur less frequently during component formation.

When the laser ultrasonic detection process occurs may be a default pattern built into the additive manufacturing process. The additive manufacturing process may, however, modify the default pattern during the additive manufacturing process in response to residual stresses detected during the additive manufacturing process. For example, if the default pattern is based on a certain level of anticipated residual stress at a given point during the additive manufacturing process, and if the actual residual stress at the given point is less, the default pattern may be amended so that more solid deposit layers 10 can be formed before the next laser ultrasonic detection process than would have been formed with the default pattern. For example, if the laser ultrasonic detection process were to occur after the most recently formed solid deposit layer 46, and again only after three more solid deposit layers 10 are formed, and if the laser ultrasonic detection process determines residual stress to be lower than anticipated when testing the most recently formed solid deposit layer 46, the default pattern may be amended to schedule the next laser ultrasonic detection process after four, or five, or more solid deposit layers 10 are formed.

Conversely, if the anticipated residual stress is greater than expected, and if the next laser ultrasonic detection process is scheduled for only after three more solid deposit layers 10 are formed, the default pattern may be amended so that the laser ultrasonic detection process occurs after each solid deposit layer 10 is formed.

FIGS. 3 and 4 show options available if the residual stress detected exceeds a predetermined threshold and a change to the additive manufacturing process in the way or residual stress relief and/or mitigation is deemed necessary. FIG. 3 depicts an option of accommodating the residual stress by forming a solid deposit layer 10 after the laser ultrasonic detection process and by differing the parameters used during the additive manufacturing process. For example, if residual stress is detected and it is determined that it can be compensated for as the instant solid deposit layer 10 is being formed, then the compensation may occur as the instant solid deposit layer 10 is being formed. Alternately, or in addition, the compensation may occur in how a subsequent solid deposit layer 80 is formed. Any, plural, or all of the process parameters associated with formation of the solid deposit layer 10 can be adjusted and the adjustment may occur in the instant and/or the subsequent solid deposit layer. These process parameters include the powder-related parameters and the laser-related parameters disclosed above, and any others known to those of ordinary skill in the art.

In an exemplary embodiment, residual stress formation in the solid deposit layer 10 being processed may be detected before the residual stress reaches a threshold, and process parameters may be adjusted to prevent further increases in the residual stress level. In another exemplary embodiment residual stress may be intentionally formed in the most recently formed solid deposit layer 46 or solid deposit 28 thereof to counter residual stress in one or more of the previously formed solid deposit layers 12. This localizes the residual stress, as opposed to possibly building upon it. Accordingly, residual stress developing in a layer being processed may be stopped, and/or previously formed residual stress may be countered via adapting the process parameters.

FIG. 4 depicts an option of performing a residual stress-relieving process after the laser ultrasonic stress detection process. Residual stress-relieving processes include those known in the art, such as shot peening (e.g. laser shot peening), laser reheating, and heat treating (e.g. inductive heat treating). Instead of, or in addition to changing the parameters associated with the formation of the subsequent solid deposit layer 80 to reduce residual stress, the stack 22 may be left in place or removed in order to perform the stress-relieving process.

In an exemplary embodiment the stack 22 is left in place for the stress-relieving process. A laser shot peening process is suitable for in-situ stress relief because the laser used may be located in the same process chamber/environment, and may be the same heating laser 14 that processes the powder. In laser shot peening the laser beam 16 may be directed at the surface 44 of the most recently formed solid deposit layer 46 or solid deposit 28 thereof to perform the shot peening process. Laser reheating may use the heating laser 14 to heat some or all of the most recently formed solid deposit layer 46 or solid deposit 28 thereof as is necessary to mitigate the residual stress. Induction heat treating may be performed in-situ when the heating coils are located in the same process chamber/environment. Induction heating may then be performed simply by activating the heating coils as necessary. In addition, to reduce residual stress the heating coils may be used to control a rate at which the melt pool 20 and/or the solidified deposit layer 10 cools. Any or all of these and other residual stress-relieving processes may be used in conjunction with each other. Further, they may be used after the solidified deposit layer 10 is being formed or while the solidified deposit layer is being formed.

FIG. 5 depicts an alternate exemplary embodiment of the laser ultrasonic process implemented during formation of the solid deposit layer 10. The two processes are shown as occurring simultaneously. Alternately, or in addition, they may be performed sequentially. In this exemplary embodiment the wave-generating laser 40 emits the wave-generating laser beam 42 toward the surface 44 of the solid deposit 28, which is the solid portion of the partially formed solid deposit layer 10. Thus, the principles disclosed above are applicable to a solid deposit 28 of a partially formed solid deposit layer 10. The laser ultrasonic process may be performed on the solid deposit 28 of a forming solid deposit layer 10, and one or more of the in-situ residual stress relieving processes may be formed on the solid deposit 28 or any other part of the stack 24. Therefore, the laser heating process, the laser ultrasonic process, and the residual stress reducing process may be performed on a solid deposit layer 10, on one solid deposit 28 of a forming solid deposit layer 10, and/or on multiple, discrete solid deposits 28 of a solid deposit layer 10, in any order, and as often as needed, in order to adapt the additive manufacturing process to accommodate residual stress.

After the stress-relieving process is performed another laser ultrasonic detection process may optionally be performed to assess the effectiveness of the stress-relieving process. If satisfactory, the subsequent solid deposit layer 80 may be formed, either using the same or different parameters as used on other solid deposit layers 10, 12. If unsatisfactory, another stress-relieving process may be performed. This process may be repeated as many times as necessary to reach the desired residual stress level, and may incorporate any combination of stress-relieving processes and changes to the subsequent solid deposit layer 80 as are necessary.

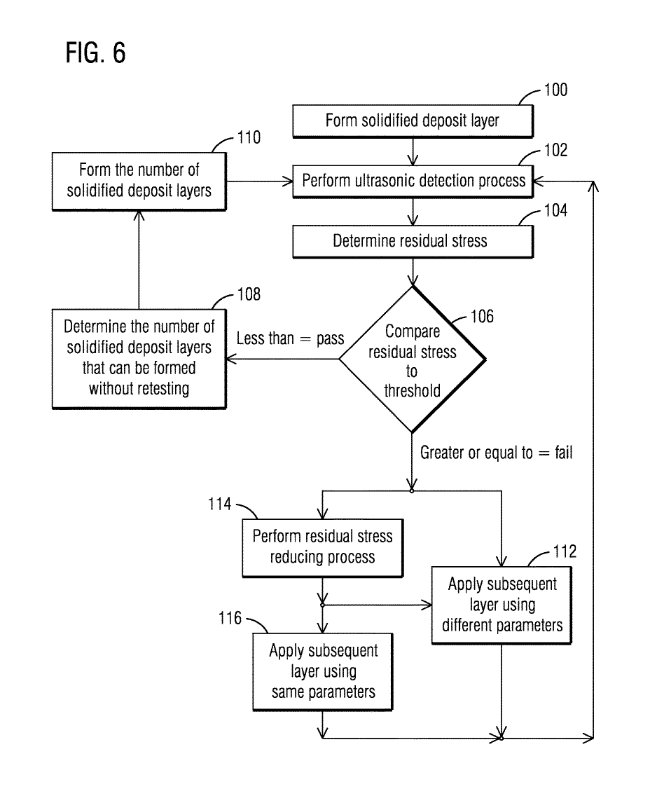

FIG. 6 is a flow chart depicting an exemplary embodiment of an additive manufacturing process employing a laser ultrasonic detection process. In step 100 the solid deposit layer 10 is formed. In step 102 the laser ultrasonic detection process is performed. In step 104 residual stress is inferred from the laser ultrasonic detection process. In step 106 a determination is made whether the residual stress is below, equals, or exceeds a threshold value. If the residual stress does not exceed the threshold value (e.g. the stack 22 passes the test), then in step 108 a determination is made as to how many more solid deposit layers 10 may be formed before another laser ultrasonic detection process is again performed. In step 110 the determined number of solid deposit layers 10 are formed, after which the process returns to step 102.

If the residual stress does exceed the threshold value (e.g. the stack 22 fails the test), then either step 112 or step 114 is performed. In step 112 the subsequent solid deposit layer 80 may be formed using different parameters for the laser heating process. In step 114 a residual stress reducing process is performed on the stack 22. Step 114 may be followed by either step 112 or step 116. In step 116 the subsequent solid deposit layer 80 may be formed using the same parameters used when one of the previously formed solid deposit layers 12 was formed. Steps 112 and 116 may be followed by step 102.

From the foregoing it can be seen that the inventors have applied recent technology to an additive manufacturing process to permit in situ, online, non-destructive testing of a component for physical defects and residual stress. The process enable the correction of certain conditions, thereby saving costs and shortened lifespan associated with parts that would not meet standards enabled by this process. Consequently, this represents an improvement in the art.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. An additive manufacturing process, comprising:
selectively heating a layer of powder to form a solid deposit layer comprising a solid deposit, wherein the solid deposit layer constitutes part of a component, via a selective laser heating process;
propagating ultrasonic energy waves through the solid deposit prior to completion of the component by using a wave generating laser set apart from a surface of the solid deposit to direct a wave-generating laser beam at the surface;
detecting propagated ultrasonic energy waves;
assessing the propagated ultrasonic waves for information about a physical characteristic of the solid deposit; and
forming another solid deposit layer in a manner responsive to the information.

2. The additive manufacturing process of claim 1, further comprising:
forming at least one underlying solid deposit layer;
depositing the layer of powder on the at least one underlying solid deposit layer when depositing the layer of powder, wherein the at least one underlying solid deposit layer constitutes a previously formed part of the component; and
determining the physical characteristic in the previously formed part of the component.

3. The additive manufacturing process of claim 1 wherein a single laser performs the selective laser heating process and generates the wave-generating laser beam.

4. The additive manufacturing process of claim 1, wherein the physical characteristic comprises residual stress.

5. The additive manufacturing process of claim 4, further comprising performing a residual stress-relieving procedure on the solid deposit, wherein the residual stress-relieving procedure comprises at least one of laser shot peening, inductive heat treating, and laser reheating the solid deposit layer.

6. The additive manufacturing process of claim 4, comprising:
using process parameters when selectively-heating the layer of powder to form the solid deposit layer;
depositing an additional layer of powder on the solid deposit layer after determining the residual stress; and
selectively-heating the additional layer of powder to form an additional solid deposit layer using different process parameters that are selected in response to the residual stress.

7. The additive manufacturing process of claim 4, further comprising:
propagating the ultrasonic energy waves through a cooling solid deposit, and using the residual stress and parametric data associated there with to predict residual stress in the solid deposit after further cooling.

8. An additive manufacturing process, comprising:
forming a component comprising plural solid deposit layers, each solid deposit layer formed via a selective laser heating process and comprising a solid deposit;
performing an ultrasonic residual stress detection process on at least one solid deposit between selective laser heating processes by using a wave-generating laser set apart from a surface of a most-recently formed or forming solid deposit to direct a wave-generating laser beam at the surface to propagate ultrasonic energy waves therein;
monitoring residual stress detected during the ultrasonic residual stress detection process; and
adjusting the additive manufacturing process if the residual stress exceeds a threshold.

9. The additive manufacturing process of claim 8, wherein a single laser performs the selective laser heating process and generates the wave-generating laser beam.

10. The additive manufacturing process of claim 8, wherein adjusting the additive manufacturing process comprises changing parameters associated with the selective laser heating process during formation of the solid deposit layer in response to the residual stress.

11. The additive manufacturing process of claim 8, wherein adjusting the additive manufacturing process comprises performing a stress-relieving process in response to the residual stress.

12. The additive manufacturing process of claim 11, wherein the stress-relieving process comprises laser shot peening, laser reheating, and inductive heat treating.

13. The additive manufacturing process of claim 8, further comprising directing a wave-detecting laser beam at the surface to detect propagated ultrasonic energy waves during the ultrasonic residual stress detection process using a wave-detecting laser set apart from the surface.

14. The additive manufacturing process of claim 13, further comprising determining how many solid deposit layers may be formed before another ultrasonic residual stress detection process is performed based on the residual stress.

15. The additive manufacturing process of claim 8, further comprising:
performing the ultrasonic residual stress detection process as the most-recently formed or forming solid deposit cools, and
using parametric data associated with the residual stress to predict residual stress after further cooling.

16. An additive manufacturing process, comprising:
iteratively forming solid deposit layers to form a stack via a selective laser heating process, wherein each layer is formed by first depositing powder and then selectively heating the powder;
propagating ultrasonic energy waves through a most-recently formed solid deposit layer by directing a wave-generating laser beam at a surface of the most-recently formed solid deposit layer using a wave-generating laser set apart from the solid deposit layers;
determining residual stress in the stack by assessing propagated ultrasonic energy waves by directing a wave-detecting laser beam at the surface of the most-recently formed solid deposit layer to detect the propagated ultrasonic energy waves, and
forming at least one of the solid deposit layers subsequent to determining the residual stress.

17. The additive manufacturing process of claim 16, further comprising determining residual stress in the most-recently formed solid deposit layer when determining residual stress in the stack.

18. The additive manufacturing process of claim 16, further comprising determining residual stress in at least one solid deposit layer disposed under the most-recently formed solid deposit layer when determining residual stress in the stack.

19. The additive manufacturing process of claim 16, further comprising at least one of a) performing at least one of a stress-relieving procedure on the stack to reduce the residual stress before forming the subsequently-formed solid deposit layer and b) changing how the subsequently-formed solid deposit layer is formed in response to the residual stress.

20. The additive manufacturing process of claim 16, wherein a single laser performs the selective laser heating process, generates the wave-generating laser beam, and generates the wave-detecting laser beam.
